(19) United States
(12) Patent Application Publication
(10) Pub. No.: US 2003/0193454 A1
(43) Pub. Date: Oct. 16, 2003

(54) Apparatus and method for driving a plasma display panel

(75) Inventors: Jun-Young Lee, Cheonan-city (KR); Dae-Gyn Kim, Cheonan-city (KR)

Correspondence Address: McGuire Woods, Suite 1800, 1750 Tysons Boulevard, McLean, VA, 22102-4215, US

(73) Assignee: Samsung SDI Co., Ltd.

(21) Appl. No.: 10/393,022

(22) Filed: Mar. 21, 2003

(30) Foreign Application Priority Data
Apr. 15, 2002 (KR) 2002-20398

(51) Int. Cl. G09G 3/28

(52) U.S. Cl. 345/63

(57) ABSTRACT

An apparatus for driving a plasma display panel includes a first driver and a second driver and a first power supplier and a second power supplier for generating sustain discharge pulses having no negative (−) level. The first driver includes a first capacitor charged to a first voltage and is coupled to a power source for supplying a voltage VS and a ground voltage. The first driver, coupled to one terminal of a panel capacitor, operates to alternately apply double the voltage Vₛ formed by the power source and the first capacitor and the ground voltage to the one terminal of the panel capacitor. The second power supplier, coupled to the power source and the ground voltage, includes a second capacitor charged to Vₛ. The second driver coupled to the other terminal of the panel capacitor operates to alternately apply double the voltage Vₛ formed by the power source and the second capacitor and the ground voltage to the other terminal of the panel capacitor. Here, one of the first driver and the second driver applies the ground voltage to the panel capacitor, while the other applies double the voltage Vₛ to the panel capacitor.

### BACKGROUND OF THE INVENTION

1. Field of the Invention

The present invention relates to an apparatus and method for driving a plasma display panel. More specifically, the present invention relates to a sustain discharge circuit for plasma display panels.

2. Description of the Related Art

A plasma display panel (PDP) is a flat panel display that uses plasma generated by gas discharge to display characters or images. The PDP includes, according to its size, more than several scores to millions of pixels arranged in a matrix pattern. Such a PDP is classified as a direct current (DC) type or an alternating current (AC) type according to its discharge cell structure and the waveform of the driving voltage applied thereto.

The DC PDP has electrodes exposed to a discharge space to allow DC to flow through the discharge space while voltage is applied, and thus requires a certain resistance for limiting the current. Contrarily, the AC PDP has electrodes covered with a dielectric layer that naturally forms a capacitance component to limit the current and to protect the electrodes from the impact of ions during a discharge, and has longevity superior to the DC PDP.

A driving method of the AC PDP includes a reset step, an addressing step, a sustain discharge step, and an erase step.

In the reset step, each cell is initialized to be ready to perform an addressing operation on the cell. In the addressing step, wall charges are formed on selected “on”-state cells (i.e., addressed cells) in the panel. In the sustain step, a discharge occurs to actually display an image on the addressed cells. In the erase step, the wall charges on the cells are erased to end the sustain discharge.

In the AC PDP, the scan and sustain electrodes for sustain discharge act as a capacitative load to form a capacitance between the scan and sustain electrodes, which is equivalently denoted as a “panel capacitor” hereinafter. Kishi et al. suggested a circuit (Japanese Patent No. 3,201,603) that applies a waveform for a sustain discharge on the scan and sustain electrodes.

In conventional circuits, however, a sustain discharge pulse swinging between positive (+) voltage Vₛ and negative (−) voltage −Vₛ is applied to the scan and sustain electrodes. With the sustain discharge pulse applied to the scan electrode and the sustain electrode for phase inversion of each other, the potential difference between the scan electrode and the sustain electrode reaches a voltage of 2Vₛ required for a sustain discharge. Individual elements used in this circuit must have a withstand voltage of Vₛ, so that any element having a low withstand voltage can be used. Such a conventional circuit, however, uses a pulse swinging from −Vₛ to Vₛ, and it cannot be used for a plasma display panel that uses a sustain discharge pulse with no negative (−) voltage.

### SUMMARY OF THE INVENTION

It is an object of the present invention to provide a PDP driver circuit using no negative (−) voltage.

It is another object of the present invention to use a switch having a low withstand voltage.

In order to achieve such objects, an apparatus for driving a PDP includes a plurality of address electrodes, a plurality of scan electrodes and sustain electrodes alternately arranged in pairs, and a panel capacitor formed among the address, scan and sustain electrodes. The driving apparatus comprises a first driver and a second driver, and a first power supplier and a second power supplier.

The apparatus has a capacitor that stores a half voltage level of the sustain voltage. When applying a voltage to one electrode of the panel capacitor, a source voltage that is serially connected to the capacitor is connected to the electrode of the panel capacitors. This forms a circuit path between the source voltage, the capacitor and the electrode of the panel capacitor. Therefore, the summation of the source voltage and the capacitor-stored voltage is applied to the electrode of the panel capacitor.

The other electrode of the panel capacitor is also connected to the same circuitry including a source voltage and a capacitor. A same configuration of circuit is formed when the voltage needs to be applied to the other electrode of the panel capacitor.

The voltages are alternately applied to each electrode of the panel capacitor in this manner. This allows the manufacturer to use a low voltage device in its component, which reduces the costs.

The apparatus may also include a voltage recovery circuit. By including an inductor and a switching device in the circuitry, the apparatus may recover the energy used in the previous discharge phase.

A method for driving such device is also disclosed.

### BRIEF DESCRIPTION OF THE DRAWINGS

FIG. 1 is an illustration of a PDP according to an embodiment of the present invention.

FIG. 2 is a circuit diagram of a driver circuit according to a first embodiment of the present invention.

FIGS. 3A and 3B are illustrations showing the current paths in the respective modes for the driver circuit according to the first embodiment of the present invention.

FIG. 4 is a timing diagram of the driver circuit according to the first embodiment of the present invention.

FIG. 5 is a circuit diagram of a driver circuit according to a second embodiment of the present invention.

FIGS. 6A through 6H are illustrations showing the current paths in the respective modes for the driver circuit according to the second embodiment of the present invention.

FIG. 7 is a timing diagram of the driver circuit according to the second embodiment of the present invention.

### DETAILED DESCRIPTION OF THE PREFERRED EMBODIMENTS

In the following detailed description, only the preferred embodiment of the invention has been shown and described, simply by way of illustrating the best mode contemplated by the inventor(s) of carrying out the invention. As will be realized, the invention is capable of modification in various obvious respects, all without departing from the invention. Accordingly, the drawings and description are to be regarded as illustrative in nature, and not restrictive. In the figures, some parts not related to the description are omitted for a better understanding of the present invention, and the same reference numerals are assigned to the same parts throughout.

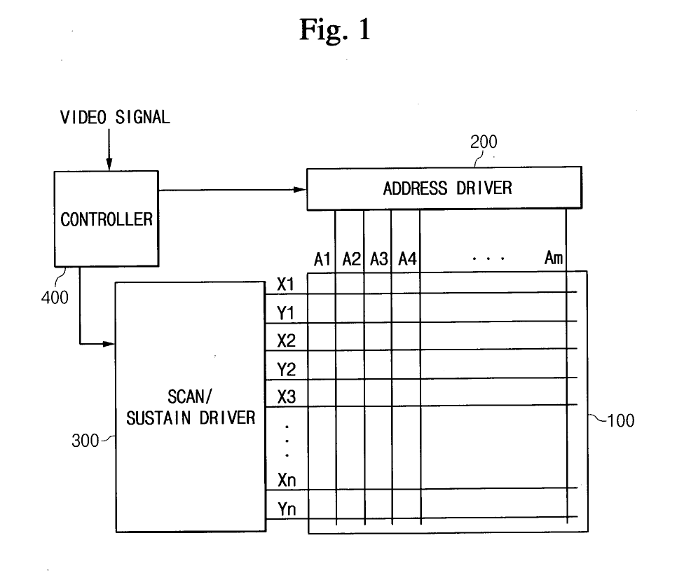

FIG. 1 is an illustration of a PDP according to an embodiment of the present invention.

The PDP according to the embodiment of the present invention comprises a plasma panel 100, an address driver 200, a scan/sustain driver 300, and a controller 400.

The plasma panel 100 comprises a plurality of address electrodes A₁ to Aₘ arranged in rows, and a plurality of scan electrodes (hereinafter referred to as “Y electrodes”) Y₁ to Yₙ and sustain electrodes (hereinafter referred to as “X electrodes”) X₁ to Xₙ alternately arranged in columns. The Y electrodes Y₁ to Yₙ are formed in correspondence with the X electrodes, with one terminal of each Y electrode being coupled to one terminal of each X electrode, respectively. When the controller 400 receives an external image signal, it generates an address drive control signal and a sustain discharge signal, and applies them to the address driver 200 and the scan/sustain driver 300, respectively.

The address driver 200 receives the address drive control signal from the controller 400 and applies a display data signal, for selection of discharge cells to be displayed, to the individual address electrodes. The scan/sustain driver 300 receives the sustain discharge signal from the controller 400 and applies a sustain discharge pulse alternately to the X and Y electrodes. The applied sustain discharge pulse causes a sustain discharge on the selected discharge cells.

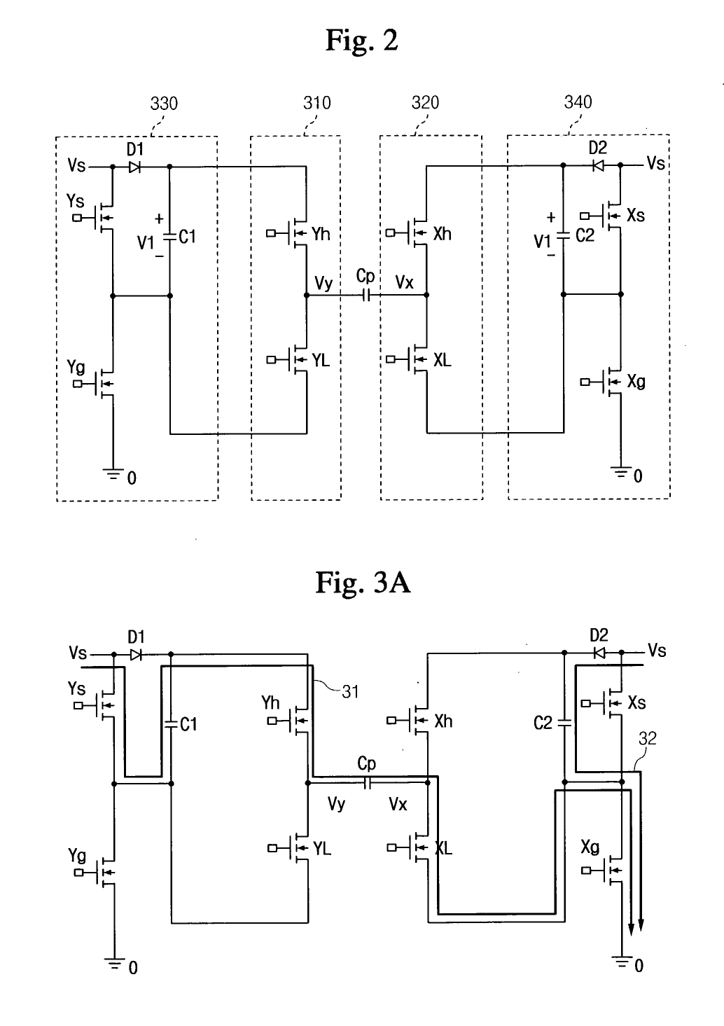

Below is a description of a driver circuit of the scan/sustain driver 300 according to a first embodiment of the present invention with reference to FIGS. 2 to 4.

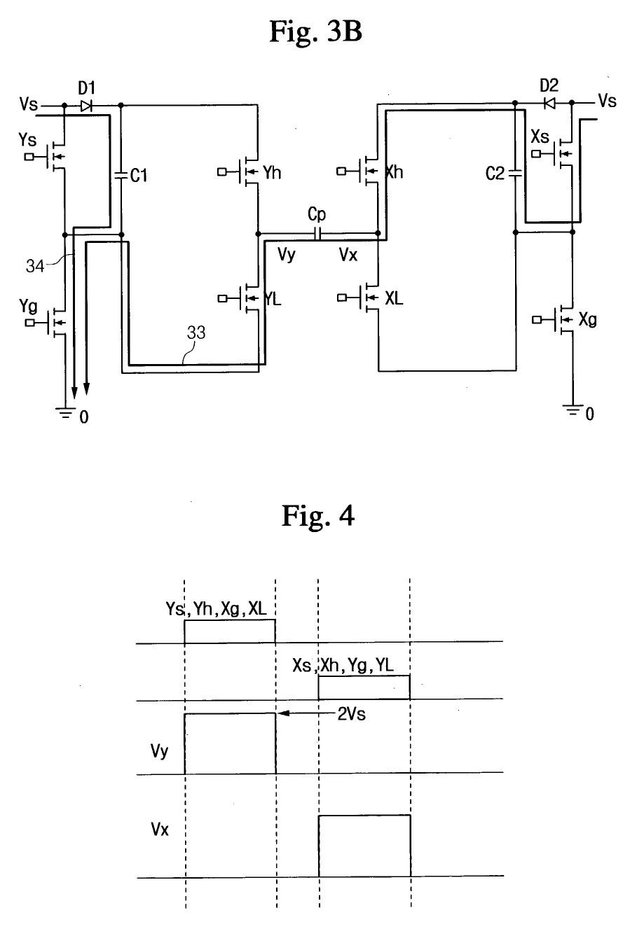

FIG. 2 is a circuit diagram of the driver circuit 300 according to the first embodiment of the present invention, FIGS. 3A and 3B are illustrations showing the current paths in the respective modes for the driver circuit according to the first embodiment of the present invention, and FIG. 4 is a timing diagram of the driver circuit 300 according to the first embodiment of the present invention.

The driver circuit 300 according to the first embodiment of the present invention comprises, as shown in FIG. 2, a Y electrode driver 310, an X electrode driver 320, a Y electrode power supplier 330, and an X electrode power supplier 340.

The Y electrode driver 310 and the X electrode driver 320 are connected to each other with a panel capacitor Cₚ therebetween. The Y electrode driver 310 comprises switches Yₕ and Y_{L} coupled in parallel to one terminal of the panel capacitor Cₚ, while the X electrode driver 320 comprises switches Xₕ and X_{L} coupled in parallel to the other terminal of the panel capacitor Cₚ.

The Y electrode power supplier 330 comprises a capacitor C₁, a diode D₁, and switches Yₛ and Y_{g}. The switches Yₛ and Y_{g} are coupled in series between a power source Vₛ and a ground terminal 0, and the contact between the switches Yₛ and Y_{g} is coupled to the switch Y_{L} of the Y electrode driver 310. The diode D₁ is coupled between the power source Vₛ and the switch Yₕ of the Y electrode driver 310, and the contact between the diode D₁ and the switch Yₕ is coupled to the other terminal of the capacitor C₁. Therefore, the switches Yₕ and Y_{L} are coupled in series to both terminals of the capacitor C₁.

The X electrode power supplier 340 comprises a capacitor C₂, a diode D₂, and switches Xₛ and X_{g}. The structure of the X electrode power supplier 340 is readily understandable with reference to the structure of the Y electrode power supplier 330 and FIG. 2, and will not be further described.

Although the switches Yₕ, Y_{L}, Xₕ, X_{L}, Yₛ, Y_{g}, Xₛ, and X_{g} are represented as a MOSFET in FIG. 2, they are not specifically limited to MOSFET and may include any switches that perform the same or similar functions. Preferably, the switches have a body diode such as a PN junction separation structure of a semiconductor integrated circuit.

Below is a description of an operation of the driver circuit according to the first embodiment of the present invention with reference to FIGS. 3A, 3B, and 4. Here, the operation changes in two modes, which are switched by manipulation of the switches Yₕ, X_{L}, Xₕ, and Y_{L}. It is assumed that the capacitors C₁ and C₂ are charged to the voltage Vₛ.

First, with the switches Xₛ, Xₕ, Y_{g}, and Y_{L} off, the switches Yₛ, Yₕ, X_{g}, and X_{L} are turned on to form a current path 31.

When the switches Yₛand Yₕ are turned on, the voltage of the power source Vₛ and the voltage Vₛ charged on the capacitor C₁ are applied to the Y electrodes of the panel capacitor Cₚ by the current path of power source Vₛ, switch Yₛ, capacitor C₁, and switch Yₕ. The applied voltage makes a Y electrode voltage V_{y} of the panel capacitor Cₚ reach 2Vₛ. Also, an X electrode voltage Vₓ of the panel capacitor Cₚ reaches the ground voltage 0V by a current path of switch X_{L} and X_{g}.

In addition, the capacitor C₂ is continuously charged to the voltage Vₛ by a current path 32 of power source Vₛ, diode D₂, capacitor C₂, switch X_{g}, and ground terminal 0.

Subsequently, the switches Yₛ, Yₕ, X_{g}, and X_{L} are turned off and the switches Xₛ, Xₕ, Y_{g}, and Y_{L} are turned on, to form a current path 33.

When the switches Xₛ and Xₕ are turned on, the voltage of the power source Vₛ and the voltage Vₛ charged on the capacitor C₁ are applied to the X electrodes of the panel capacitor Cₚ by the current path of power source Vₛ, switch Xₛ, capacitor C₂, and switch Xₕ. The applied voltage makes the X electrode voltage Vₓ of the panel capacitor Cₚ reach 2Vₛ. Also, the Y electrode voltage V_{y} of the panel capacitor Cₚ reaches the ground voltage 0V by a current path of switches Y_{L} and Y_{g}.

In addition, capacitor C₁ is charged to the voltage Vₛ by a current path 34 of power source Vₛ, diode D₁, capacitor C₁, switch Y_{g}, and ground terminal 0.

According to the first embodiment of the present invention, as described above, the potential difference between the X and Y electrodes can be a sustain discharge voltage 2Vₛ by generating a sustain discharge pulse swinging from zero to 2Vₛ.

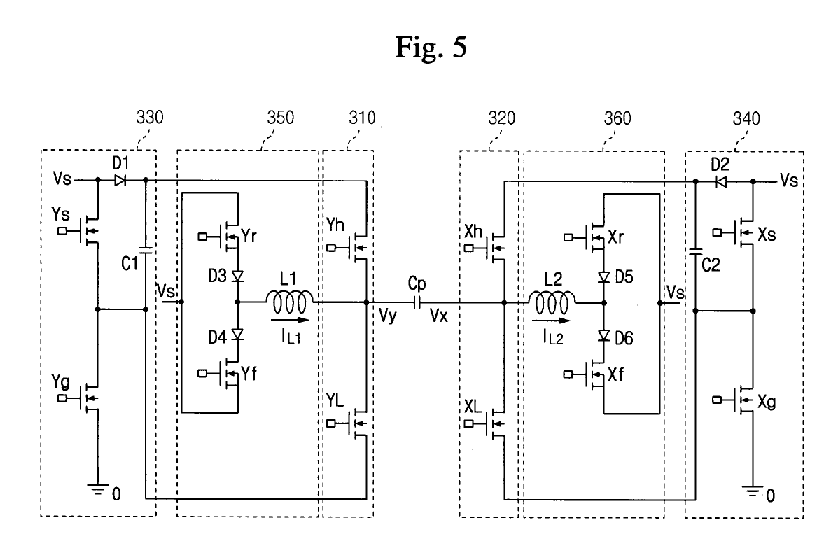

The driver circuit 300 according to the first embodiment of the present invention may include a power recovery circuit for recovering reactive power and reusing it. Below is a description of an embodiment with the addition of a power recovery circuit, with reference to FIGS. 5 to 7.

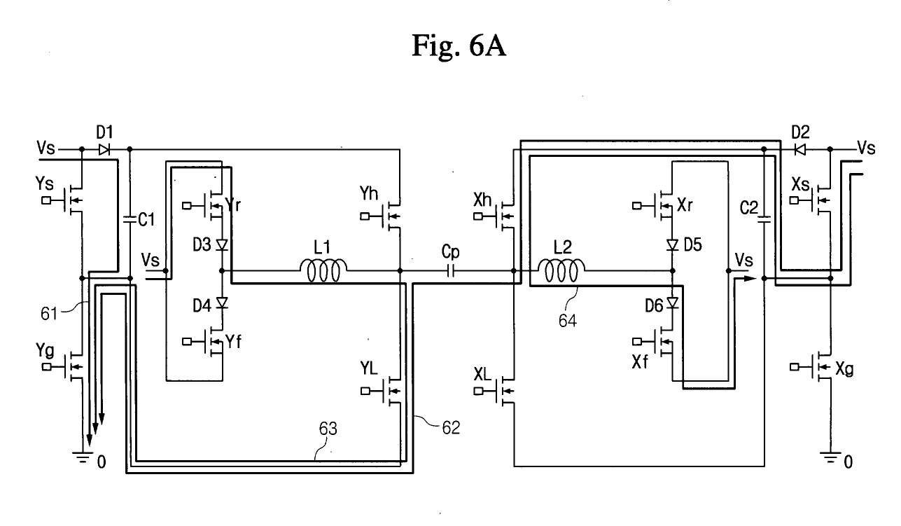

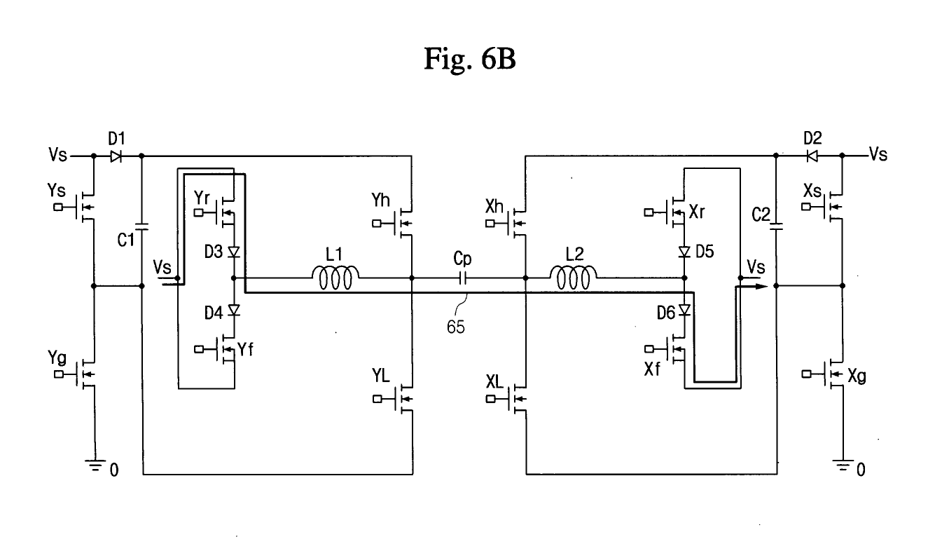

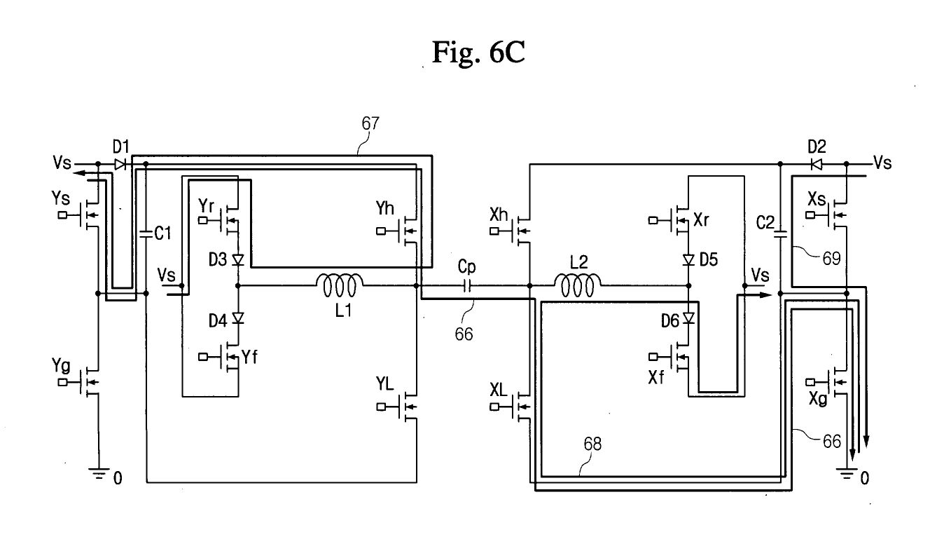

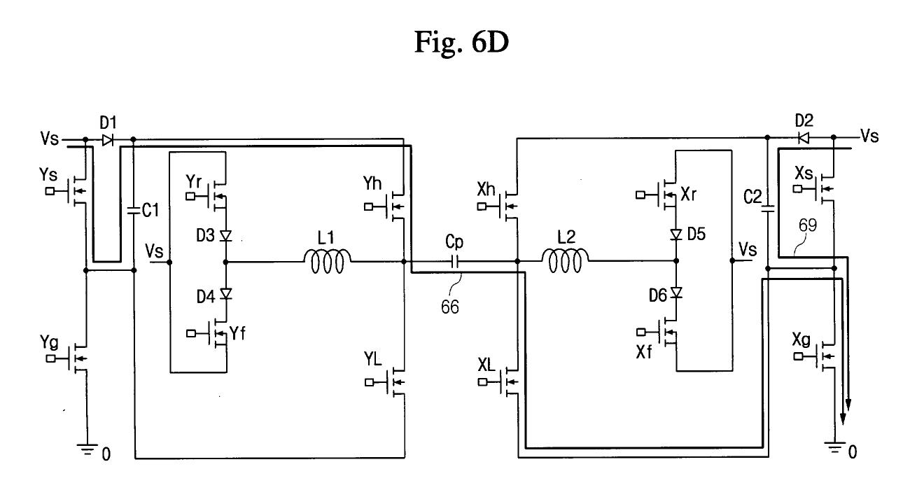

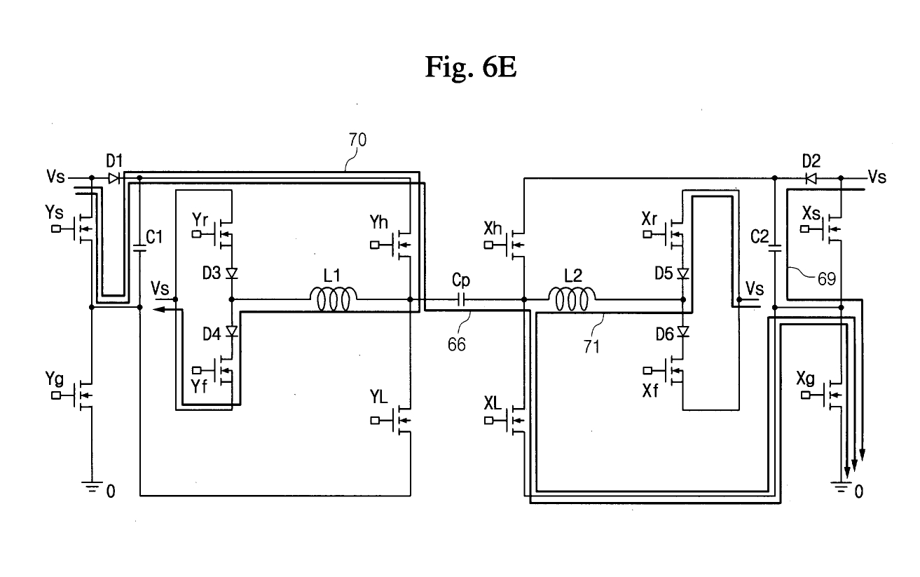

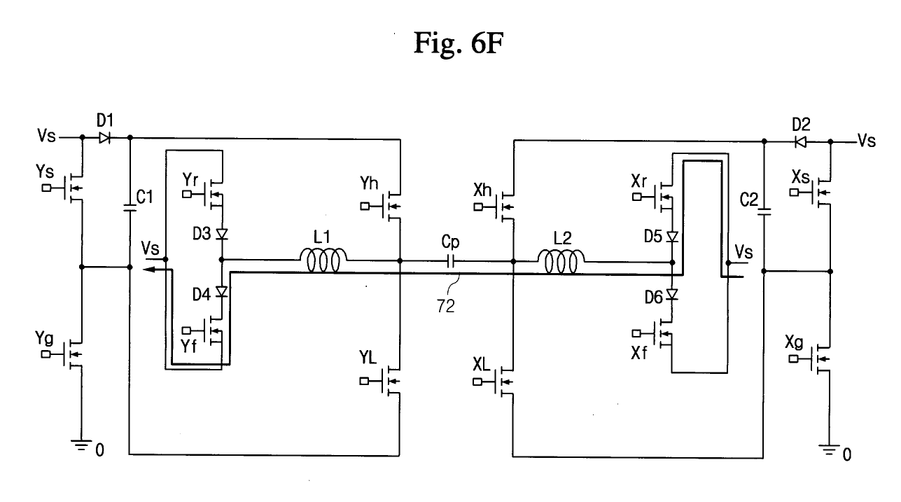

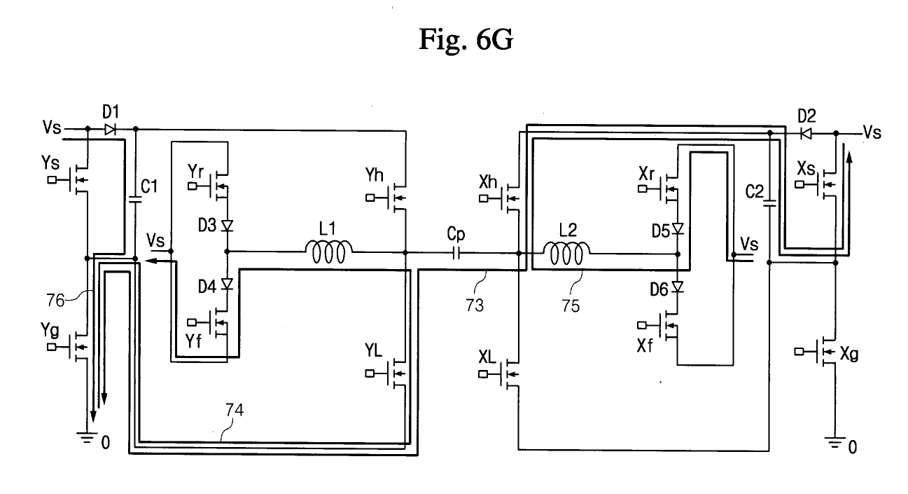

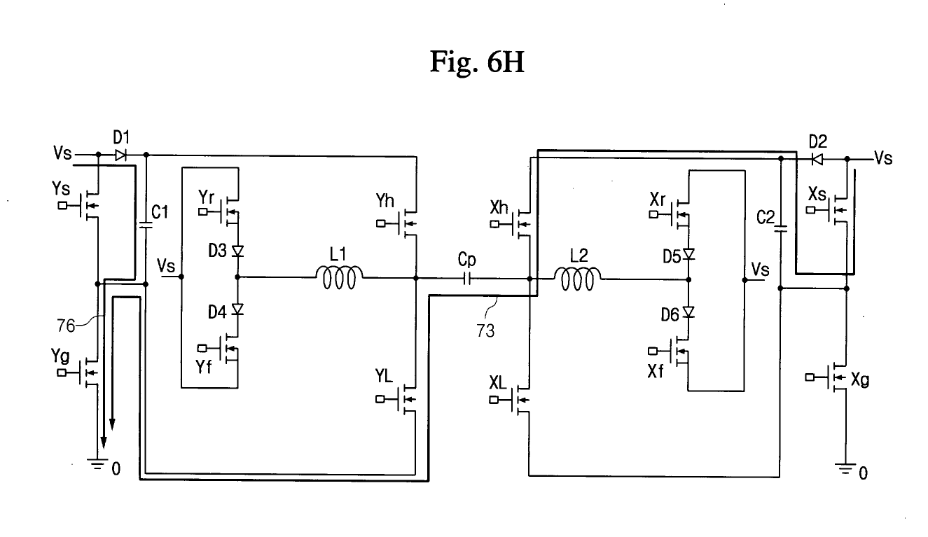

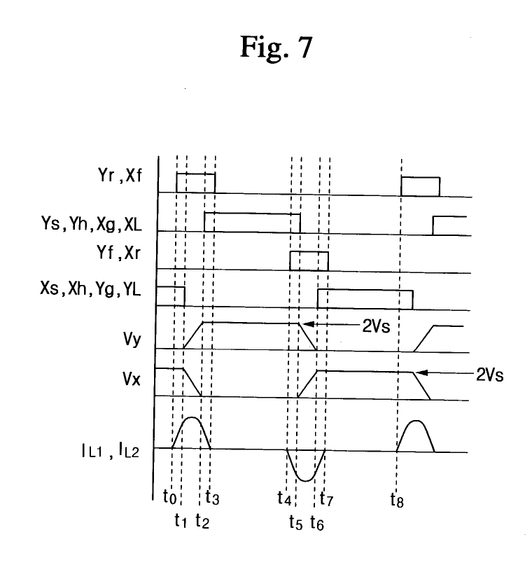

FIG. 5 is a circuit diagram of the driver circuit according to a second embodiment of the present invention, FIGS. 6A to 6H are illustrations showing the current paths in the respective modes for the driver circuit according to the second embodiment of the present invention, and FIG. 7 is a timing diagram of the driver circuit according to the second embodiment of the present invention.

The driver circuit 300 according to the second embodiment of the present invention comprises, as shown in FIG. 5, Y electrode power recovery section 350 and X electrode power recovery section 360 added to the driver circuit of the first embodiment of the present invention.

The Y electrode power recovery section 350 comprises an inductor L₁ and switches Yᵣ and Y_{f}. The inductor L₁ has one terminal coupled to a contact between the switches Yₕ and Y_{L}, i.e., the Y electrode of the panel capacitor Cₚ. The switches Yᵣ and Y_{f} are coupled in parallel between the other terminal of the inductor L₁ and the power source Vₛ. The Y electrode power recovery section 350 may further comprise diodes D₃ and D₄ coupled between the switches Yᵣ and Y_{f} and the inductor L₁, respectively. The diodes D₃ and D₄ form a current path to the inductor L₁ and a current path from the inductor L₁.

The X electrode power recovery section 360 comprises an inductor L₂ and switches Xᵣ and X_{f}, and further diodes D₅ and D₆. The structure of the X electrode power recovery section 360 is the same as that of the Y electrode power recovery section 350 and will not be further described. The switches Yᵣ, Y_{f}, Xᵣ, and X_{f} may comprise MOSFETs.

Below is a description of an operation of the driver circuit according to the second embodiment of the present invention with reference to FIGS. 6A through 6H and 7. Here, the operation changes in eight modes, which are switched by manipulation of switches. The phenomenon called “LC resonance” herein, is not a continuous oscillation but a change in voltage and current caused by the combination of the inductors L₁ and L₂ and the panel capacitor Cₚ when the switches Yᵣ, X_{f}, Xᵣ, and Y_{f} are turned on.

In the second embodiment of the present invention, it is assumed that before the start of Mode 1, the switches Xₛ, Xₕ, Y_{g}, and Y_{L} are in the “on” position, with the switches Yₛ, Yₕ, X_{g}, X_{L}, Y_{f}, Xᵣ, Yᵣ, and X_{f} off. It is also assumed that the capacitors C₁ and C₂ are charged to a voltage of Vₛ and that the inductance of the inductors L₁ and L₂ is L.

(1) Mode 1 (t0 to t1)

Reference will be made to FIG. 6A and the t0-t1 interval of FIG. 7 to describe the operation in Mode 1.

Before the start of Mode 1, the capacitor C₁ is charged to a voltage of Vₛ by a current path including power source Vₛ, diode D₁, capacitor C₁, and switch Y_{g}. Also, a current path 62 is formed that includes power source Vₛ, switch Xₛ, capacitor C₂, switch Xₕ, panel capacitor Cₚ, switch Y_{L}, switch Y_{g}, and ground voltage. Then, due to the power source Vₛ and the voltage of Vₛ charged on the capacitor C₂, the X electrode voltage Vₓ of the panel capacitor Cₚ is sustained at 2Vₛ. As the Y electrode is coupled to the ground voltage, the Y electrode voltage V_{y} is sustained at 0V.

Here, turning on the switches Yᵣ and X_{f} forms a current paths 63 and 64. The current path 63 includes power source Vₛ, switch Yᵣ, diode D₃, inductor L₁, switch Y_{L}, switch Y_{g}, and ground voltage. A current path 64 includes power source Vₛ, switch Xₛ, capacitor C₂, switch Xₕ, inductor L₂, diode D₆, switch X_{f}, and power source Vₛ. By the current paths 63 and 64, currents IL₁ and IL₂ flowing to the inductors L₁ and L₂ linearly increase with a slope of Vₛ/L and (2Vₛ−Vₛ)/L(=Vₛ/L), respectively. Hence the energy is stored in the inductors L₁ and L₂ due to the currents IL₁ and IL₂.

(2) Mode 2 (t1 to t2)

Reference will be made to FIG. 6B and the t1-t2 interval of FIG. 7 to describe the operation in Mode 2.

In Mode 2, with the switches Yᵣ and X_{f} on, the switches Xₛ, Xₕ, Y_{g}, and Y_{L} are turned off. Then, a current path 65 is formed that includes power source Vₛ, switch Yᵣ, diode D₃, inductor L₁, panel capacitor Cₚ, inductor L₂, diode D₆, switch X_{f}, and power source Vₛ, so that an LC resonance current flows due to the inductors L₁ and L₂ and the panel capacitor Cₚ. With this LC resonance current, the Y electrode voltage V_{y} of the panel capacitor Cₚ is increased to 2Vₛ, and the X electrode voltage Vₓ is reduced to 0V. Therefore, the energy stored in the inductors L₁ and L₂ is used to change the Y and X electrode voltages of the panel capacitor Cₚ.

(3) Mode 3 (t2˜t3)

Reference will be made to FIG. 6C and the t2-t3 interval of FIG. 7 to describe the operation in Mode 3.

In Mode 3, with the switches Yᵣ and X_{f} on, the switches Yₛ, Yₕ, X_{g}, and X_{L} are turned on. A current path 66 is then formed that includes power source Vₛ, switch Yₛ, capacitor C₁, switch Yₕ, panel capacitor Cₚ, switch X_{L}, switch X_{g}, and ground voltage. Due to the power source Vₛ and the voltage of Vₛ charged on the capacitor C₁, the Y electrode voltage V_{y} of the panel capacitor Cₚ is sustained at 2Vₛ. As the X electrode is coupled to the ground voltage, the X electrode voltage Vₓ is sustained at 0V.

A current path 67 is formed that includes power source Vₛ, switch Yᵣ, diode D₃, inductor L₁, the body diode of switch Yₕ, capacitor C₁, the body diode of switch Yₛ, and power source Vₛ. Also, a current path 68 is formed that includes ground voltage, the body diode of switch X_{g}, the body diode of switch X_{L}, inductor L₂, diode D₆, switch X_{f}, and power source Vₛ. By the current paths 67 and 68, currents flowing to the inductors L₁ and L₂ linearly decrease to zero with a slope of (Vₛ−2Vₛ)L and (0−Vₛ)/L, i.e., −Vₛ/L, respectively. Hence the energy stored in the inductors L₁ and L₂ is recovered to the power source Vₛ.

In addition, a current path 69 is formed that includes another power source Vₛ, diode D₂, capacitor C₂, switch X_{g}, and ground voltage, thereby charging a voltage of Vₛ on the capacitor C₂.

(4) Mode 4 (t3˜t4)

Reference will be made to FIG. 6D and the t3-t4 interval of FIG. 7 to describe the operation in Mode 4.

In Mode 4, with the switches Yₛ, Yₕ, X_{g}, and X_{L} on, the switches Yᵣ and X_{f} are turned off. By the current path 66 formed in Mode 3, the Y and X electrode voltages V_{y} and Vₓ of the panel capacitor Cₚ are still sustained at 2Vₛ and 0V, respectively. The capacitor C₂ is continuously charged to the voltage of Vₛ by the current path 69 formed in Mode 3.

(5) Mode 5 (t4 t5)

Reference will be made to FIG. 6E and the t4-t5 interval of FIG. 7 to describe the operation in Mode 5.

In Mode 5, with the switches Yₛ, Yₕ, X_{g}, and X_{L} on, the switches Y_{f} and Xᵣ are turned on. By the current paths 66 and 69 formed in Mode 3, the Y and X electrode voltages V_{y} and Vₓ of the panel capacitor Cₚ are sustained at 2Vₛ and 0V, respectively, and the capacitor C₂ is still charged to the voltage of Vₛ.

With the switches Y_{f} and Xᵣ on, a current path 70 is formed that includes power source Vₛ, switch Yₛ, capacitor C₁, switch Yₕ, inductor L₁, diode D₄, switch Y_{f}, and power source Vₛ, and a current path 71 is formed that includes power source Vₛ, switch Xᵣ, diode D₅, inductor L₂, switch X_{L}, switch X_{g}, and ground voltage. By the current paths 70 and 71, the currents IL₁ and IL₂ flowing to the inductors L₁ and L₂ are linearly decreased from zero with a slope of (2Vₛ−Vₛ)L and (Vₛ−0)/L, i.e., Vₛ/L, respectively (these currents are opposite in direction to those in Mode 1 and are denoted as a negative (−) value in FIG. 7). Hence the energy is stored in the inductors L₁ and L₂.

(6) Mode 6 (t5 to t6)

Reference will be made to FIG. 6F and the t5-t6 interval of FIG. 7 to describe the operation in Mode 6.

In Mode 6, with the switches Y_{f} and Xᵣ on, the switches Yₛ, Yₕ, X_{g}, and X_{L} are turned off. The current paths 66, 69, 70, and 71 formed in Mode 5 are then stopped, to form a current path 72 that includes power source Vₛ, switch Xᵣ, diode D₅, inductor L₂, panel capacitor Cₚ, inductor L₁, diode D₄, switch Y_{f}, and power source Vₛ. The current path 72 makes an LC resonance current flow due to the inductors L₁ and L₂ and the panel capacitor Cₚ. With this LC resonance current, the Y electrode voltage V_{y} of the panel capacitor Cₚ decreases to zero and the X electrode voltage Vₓ increases to 2Vₛ. That is, the energy stored in the inductors L₁ and L₂ is used to change the Y and X electrode voltages of the panel capacitor Cₚ.

(7) Mode 7 (t6˜t7)

Reference will be made to FIG. 6G and the t6-t7 interval of FIG. 7 to describe the operation in Mode 7.

In Mode 7, with the switches Y_{f} and Xᵣ on, the switches Xₛ, Xₕ, Y_{g}, and Y_{L} are turned on. A current path 73 is then formed that includes power source Vₛ, switch Xₛ, capacitor C₂, switch Xₕ, panel capacitor Cₚ, switch Y_{L}, switch Y_{g}, and ground voltage. This sustains the Y and X electrode voltages V_{y} and Vₓ of the panel capacitor Cₚ at 0V and 2Vₛ, respectively.

Then, a current path 74 is formed that includes ground voltage, the body diode of switch Y_{g}, the body diode of switch Y_{L}, inductor L₁, diode D₄, switch Y_{f}, and power source Vₛ, and a current path 75 is formed that includes power source Vₛ, switch Xᵣ, diode D₅, inductor L₂, the body diode of switch Xₕ, capacitor C₂, the body diode of switch Xₛ, and power source Vₛ. By the current paths 74 and 75, currents flowing to the inductors L₁ and L₂ linearly decrease to zero with a slope of −Vₛ/L (these currents are opposite in direction to those in Mode 3 and are denoted as a negative (−) value in FIG. 7). Therefore, the energy stored in the inductors L₁ and L₂ is recovered to the power source Vₛ.

In addition, a current path 76 is formed that includes power source Vₛ, diode D₁, capacitor C₁, switch Y_{g}, and ground voltage, thereby charging a voltage of Vₛ on the capacitor C₁.

(8) Mode 8 (t7˜t8)

Reference will be made to FIG. 6H and the t7-t8 interval of FIG. 7 to describe the operation in Mode 8.

In Mode 8, with the switches Xₛ, Xₕ, Y_{g}, and Y_{L} on, the switches Y_{f} and Xᵣ are turned off. By the current path 73 formed in Mode 7, the Y and X electrode voltages V_{y} and Vₓ of the panel capacitor Cₚ are still sustained at 0V and 2Vₛ, respectively. The capacitor C₁ is continuously charged to the voltage of Vₛ by the current path 76 formed in Mode 7.

Subsequently, the cycle of Modes 1 to 8 is repeated to generate a sustain discharge pulse having no negative (−) level, thereby providing a potential difference between the X and Y electrodes as a sustain discharge voltage of 2Vₛ.

Although each of the Y electrode power recovery sections 350 and X electrode power recovery section 360 has one inductor in the second embodiment of the present invention, other differently modified power recovery sections may be used. For example, the Y electrode power recovery section 350 may include inductors L₁₁ and L₁₂, each forming a different path. That is, energy is stored in the inductor L₁₁ while the Y electrode voltage is sustained at 2Vₛ, and it is then used to change the Y electrode voltage to 0V. The energy stored in the inductor L₁₂ is recovered while the Y electrode voltage is sustained at 0V, and energy is stored in the inductor L₁₂ and then used to change the Y electrode voltage to 2Vₛ.

As described above, according to the present invention, only the power source Vₛ supplying a voltage of Vₛ is used to generate a sustain discharge pulse swinging from 0V to 2Vₛ, thereby making it possible to use conventional switches having a low withstand voltage and to generate a sustain discharge pulse having no negative (−) level.

While this invention has been described in connection with what is presently considered to be the most practical and preferred embodiment, it is to be understood that the invention is not limited to the disclosed embodiments, but, on the contrary, is intended to cover various modifications and equivalent arrangements included within the spirit and scope of the appended claims.

Having thus described our invention, what we claim as new and desire by letters patent is as follows:

1. An apparatus for driving a plasma display panel that includes a plurality of address electrodes, a plurality of scan electrodes and sustain electrodes alternately arranged in pairs, and a panel capacitor formed among the address electrode, scan electrode and the sustain electrode, the apparatus comprising:
a first driver including a first switch and a second switch coupled in parallel to one terminal of the panel capacitor; and
a first power supplier including a third switch and a fourth switch coupled in series between a first power source for supplying a first voltage and a second power source for supplying a second voltage, and having a contact thereof coupled to the second switch, a first diode coupled between the first power source and the first switch, and a first capacitor coupled between a contact between the first diode and the first switch and a contact between the third switch and the fourth switch.

2. The apparatus of claim 1, further comprising:
a power recovery section coupled between a contact between the first switch and the second switch and the first power source.

3. The apparatus of claim 2, wherein the power recovery section comprises:
an inductor coupled to the one terminal of the panel capacitor; and
a fifth switch and a sixth switch coupled in parallel between the first power source and the first inductor.

4. The apparatus of claim 3, wherein the power recovery section further comprises:
a second diode coupled between the fifth switch and the first inductor; and
a third diode coupled between the first inductor and the sixth switch.

5. The apparatus of claim 1, wherein each of the first switch, the second switch, the third switch and the fourth switch has a body diode.

6. The apparatus of claim 1, wherein the first voltage is a half of the voltage required for a sustain discharge and the second voltage is a ground voltage.

7. The apparatus as claimed in claim 1, further comprising:
a second driver including a fifth switch and a sixth switch coupled in parallel to another terminal of the panel capacitor;
a second power supplier including a seventh switch and eighth switch coupled in series between the first power source and the second power source and having a contact thereof coupled to the sixth switch, a second diode coupled between the first power source and the fifth switch, and a second capacitor coupled between a contact between the second diode and the fifth switch and a contact between a seventh switch and an eighth switch.

8. An apparatus for driving a plasma display panel that includes a plurality of address electrodes, a plurality of scan and sustain electrodes alternately arranged in pairs, and a panel capacitor formed among the address, scan and sustain electrodes, the apparatus comprising:
a first power supplier coupled between a first power source and a second power source for supplying a first voltage and a second voltage, respectively, the first power supplier including a first capacitor charged to a third voltage; and
a first driver coupled to one terminal of the panel capacitor and operating to alternately apply a summation of the first voltage and the third voltage formed by the first power source and the first capacitor and the second voltage to the one terminal of the panel capacitor.

9. The apparatus of claim 8, wherein the first power supplier further includes a first switch coupled between the first capacitor and the second power source and operating to charge the first capacitor with the third voltage.

10. The apparatus of claim 8, wherein the first power supplier further includes a first switch operating to couple the first capacitor charged to the third voltage in series to the first power source.

11. The apparatus of claim 8, further comprising:
a power recovery section including at least one inductor coupled to the one terminal of the panel capacitor, the power recovery section storing energy in the inductor while either one terminal of the panel capacitor is sustained at a fourth voltage, and using the energy stored in the inductor to change the both terminal voltages of the panel capacitor.

12. The apparatus of claim 11, wherein the energy remaining in the inductor is recovered, after both terminal voltages of the panel capacitor are changed.

13. The apparatus as claimed in claim 8, further comprising:
a second power supplier including a second capacitor charged to the third voltage, the second power supplier being coupled between the first and second power sources; and
a second driver coupled to the other terminal of the panel capacitor and operating to alternately apply a summation of the first voltage and the third voltage formed by the first power source and the second capacitor and the second voltage to another terminal of the panel capacitor,
wherein one of the first driver and the second driver applies the second voltage to the panel capacitor while the other applies the summation of the first voltage and the third voltage to the panel capacitor.

14. The apparatus as claimed in claim 13, wherein the second power supplier charges the second capacitor with the third voltage while the first driver applies the summation of the first voltage and the third voltage to the one terminal of the panel capacitor; and the first power supplier charges the first capacitor with the third voltage while the second driver applies the summation of the first voltage and the third voltage to the other terminal of the panel capacitor.

15. A method for driving a plasma display panel that includes a plurality of address electrodes, a plurality of scan electrodes and sustain electrodes alternately arranged in pairs, and a panel capacitor formed among the address electrode, the scan electrode and a sustain electrode, the method comprising steps of:
(a) applying a summation of the first and second voltages to one terminal of the panel capacitor through a first power source for supplying a first voltage and a first capacitor charged to a second voltage and coupling the other terminal of the panel capacitor to a third voltage; and
(b) applying the summation of the first and second voltages to the other terminal of the panel capacitor through another first power source and a second capacitor charged to the second voltage and coupling the one terminal of the panel capacitor to the third voltage.

16. The method of claim 15, wherein the step (a) further comprises a step of:
charging the second capacitor with the second voltage, and wherein the step (b) further comprises a step of:
charging the first capacitor with the second voltage.

17. A method for driving a plasma display panel that includes a plurality of address electrodes, a plurality of scan electrodes and sustain electrodes alternately arranged in pairs, and a panel capacitor formed among the address electrode, the scan electrode and the sustain electrode, the method comprising steps of:
(a) storing energy in a first inductor coupled to one terminal of the panel capacitor and at least one second inductor coupled to the other terminal of the panel capacitor, while the one terminal of the panel capacitor is sustained at a level of a summation of the first voltage and the second voltage and the other terminal of the panel capacitor is sustained at a third voltage;
(b) applying the third voltage to the one terminal of the panel capacitor and the summation of the first voltage and the second voltage to the other terminal of the panel capacitor using the energy stored in the first and second inductors; and
(c) sustaining the other terminal of the panel capacitor at the summation of the first and second voltages, and recovering the energy stored in the first inductor and the second inductor through a first capacitor coupled to the other terminal of the panel capacitor and charged to the second voltage and a first power source for supplying the first voltage.

18. The method of claim 17, further comprising steps of:
(d) storing energy in the first inductor and the second inductor, while the one terminal of the panel capacitor is sustained at the third voltage and the other terminal of the panel capacitor is sustained at the summation of the first voltage and the second voltage;
(e) using the energy stored in the first inductor and the second inductor so as to apply the summation of the first voltage and the second voltage to the one terminal of the panel capacitor and the third voltage to the other terminal of the panel capacitor; and
(f) sustaining the one terminal of the panel capacitor at the summation of the first and second voltages, and recovering the energy stored in the first and second inductors through a second capacitor coupled to the one terminal of the panel capacitor and charged to the second voltage and the first power source.

19. The method of claim 18, wherein each of the step (a) and the step (f) further comprise a step of:
charging the first capacitor with the second voltage, and
wherein each of the step (c) and the step (d) further comprises a step of:
charging the second panel capacitor with the second voltage.

20. The method of claim 19, further comprising the step of repeating steps (a) through (f).
